(19) United States
(12) Patent Application Publication
(10) Pub. No.: US 2003/0039169 A1
(43) Pub. Date: Feb. 27, 2003

(54) Micromixer

(76) Inventors: Wolfgang Ehrfeld, Mainz (DE); Volker Hessel, Hunstetten-Wallbach (DE)

Correspondence Address: Hudak & Shunk Company, Suite 808, 7 West Bowery Street, Akron, OH, 44308-1133, US

(21) Appl. No.: 10/149,994

(22) PCT Filed: Dec. 14, 2000
(86) PCT No.: PCT/EP00/12736

(30) Foreign Application Priority Data
Dec. 18, 1999 (DE) 19961257.9

(51) Int. Cl. B01F 5/00

(52) U.S. Cl. 366/336; 366/340; 366/341

(57) ABSTRACT

Micromixers constitute a main component of microreactors that have three-dimensional microstructures in a fixed matrix, in which chemical reactions take place. In said micromixer, fluids from their respective supply chambers are divided into spatially separated fluid streams using a network of microchannels allocated to the respective streams. Said streams then emerge as jets with identical volumetric flows for each fluid into a mixing chamber. The invention aims to ensure that identical volumetric flows are achieved for each fluid at the respective microchannel outflow and to produce a micromixer with a simple, compact construction. Wedge-shaped plates can be used as the supply elements (2a-d). Said plates can be assembled to form at least one ring sector which surrounds the mixing chamber (5) in the form of a curve. Alternatively, planar plates can be used which comprise a cavity in their central region, into which the microchannels (31-34) provided for each fluid form one or more symmetrical bifurcation cascades (3) comprising at least two stages. The micromixer can be used in microreactors, for example in the field of combined chemistry, for creating emulsion and gaseous/liquid dispersions and for gas-phase catalysis.

### DESCRIPTION

The invention relates to a static micromixer in accordance with the preamble of claim 1. The invention further relates to a static micromixer in accordance with the preamble of claim 15.

Micromixers constitute a main component of microreactors that have three-dimensional microstructures in a fixed matrix, in which chemical reactions take place. These microreactors have become increasingly important, for instance, in combinatorial chemistry for producing emulsions and gas/liquid dispersions and in gas phase catalysis.

In a micromixer, typically at least two fluids from their respective supply chambers are divided into spatially separate fluid streams using a network of microchannels allocated to the respective streams. Said streams then emerge as jets with identical volumetric flow for each fluid into a mixing or reaction chamber. Each fluid jet is guided adjacent another jet of a different fluid into the mixing and reaction chamber, in which they are mixed by diffusion and/or turbulence. It is important that identical volumetric flows of each fluid are introduced into the mixing or reaction chamber through the microchannels because the mixing ratios would otherwise vary spatially within the mixing or reaction chamber, which would distort the mixing or reaction result. Since the volumetric flows are affected by pressure losses in the microchannels, the microchannel systems must be configured in such a way that all the microchannel branches are subject to an identical and—ideally—low pressure loss.

Publication WO 95/30476 discloses a static micromixer with a mixing chamber and a flow guide structure for the separate supply of the substances to be mixed. Said flow guide structure consists of stacked plate-like elements in the form of thin foils, each with a system of parallel linear grooves. The grooves of the stacked foils have an alternate slope relative to the longitudinal axis of the micromixer, such that the openings of the channels abutting the mixing chamber are aligned one over the other and on the fluid inlet side diverge into separate inlet chambers. The channels of the flow guide structure each have the same length and thus the same flow resistance. However, since the sloped arrangement of the microchannels causes the fluids to flow into the mixing chamber toward different sides, the mixing efficiency is lower along the edge zones than in the center due to the influence of wall friction of the mixing chamber.

To increase the local mixing efficiency, German Patent Specification DE 195 40 292 C1 proposes that the corresponding groove networks in the stacked foils are each curved and alternately extend from the mixing chamber to one of the two feed chambers, such that all the grooves are aligned parallel to one another as they open out into the mixing chamber. To achieve identical flow resistance, it is proposed that the sides of the flow guide structures that abut the mixing chamber be sloped compared to the side abutting the mixing chamber [sic] such that the channels have approximately the same length. To avoid curved inlet surfaces, it is specified that said surfaces be oriented along an approximate straight line, which is to be determined according to a specified formula. However, this permits only small arc angles of the grooves, such that an arrangement of the supply chambers on two opposite sides of the flow guide structure or a separate feed of more than two fluids would be difficult to realize.

The prior-art microchannel systems have the drawback that special supply chambers are required and that all the microchannels issuing from the corresponding supply chambers must be uniformly supplied with the respective fluid, i.e. the jet pressure of the inflowing fluid must be homogenized. For this purpose, extended supply chambers must be provided, which may cause space problems and which increases the retention time of the fluid. Despite these supply chambers, homogenization of the jet pressure is guaranteed only over a limited pressure range and thus a limited volumetric flow range.

German Patent Specification DE 35 46 091 C2 describes a cross-flow microfilter with a supply distributor and a collector for the concentrate, which are connected upstream and downstream, respectively. Such a supply distributor can be configured in the form of a bifurcation structure, wherein a number of curved partitions corresponding to the number of bifurcation cascades is required to form this bifurcation structure.

The publication entitled “A Microflow Reactor for Two-Dimensional Investigations of In-Vitro Amplification Systems,” Microreaction Technology, Proceedings of the First International Conference on Microreaction Technology (Editor: W. Ehrfeld), Springer 1998, presents a microreactor that comprises a plenum chamber in a supply layer. Two bifurcation cascades through which a fluid is introduced discharge on opposite sides into said plenum chamber. From there, the fluid reaches a reaction chamber via a pressure barrier.

An article in Chemische Technik 26, Vol. 1997, No. 1, pp. 131-134, describes microreactors in chemistry comprising a plurality of stacked plates with a groove structure for supplying the reactants. Behind the reaction and mixing area, after a heat exchange section, a bifurcation cascade is provided for the confluence of the individual streams.

The object of the invention is to provide a micromixer with microchannels, at the outflow of which the volumetric flow of each fluid is identical. This micromixer should be distinguished by a simple and compact design.

This object is attained by supply elements in the form of wedge-shaped plates, which can be assembled to form at least one ring sector that surrounds the mixing chamber in the form of a curve. The microchannels provided for each fluid form a symmetrical bifurcation cascade comprising at least two stages i (i=1 to n, where n≧2).

This object is furthermore attained by supply elements in the form of flat plates, which have an opening in their central region into which the micro channels open, such that the stacked plates form the mixing chamber. The micro channels provided for each fluid form one or more bifurcation cascades comprising at least two stages i (i=1 to n, where n≧2).

The successive division of a fluid stream into two equal partial streams, which in turn are divided into 2+2=4 partial streams, and are then further divided in stages, has the result that all the streams of a fluid are subject to the same conditions and, consequently, identical volumetric flows of each fluid pass into the mixing or reaction chamber. This division into partial streams, which are all subject to the same conditions as far as possible, is achieved by reducing the cross sections of the microchannels from stage to stage. Depending on their shape, the cross sections can be reduced by reducing their width and/or depth or their radius in the case of round cross sections. Especially if the supply elements are wedge-shaped plates, it is recommended to vary the depth to make good use of the volume available in the form of the supply element. The fact that all the partial streams of a fluid are in addition fed from a reservoir further contributes to the similarity of the conditions.

A further advantage is that each bifurcation cascade issues from a single fluid stream (supply channel), which communicates with the reservoir, so that no spatially extended supply chambers are necessary. The supply channels can be much better adapted to the corresponding local conditions, so that a compact micromixer can be realized.

Reservoirs can be arranged outside the micromixer at any point and in any number, which also permits the mixing of more than two fluids.

The supply elements in the form of wedge-shaped plates, which can be assembled to form a ring sector, or also a closed ring, contribute to the compact design. Since the depth of the microchannels decreases in the direction of the mixing chamber, the wedge shape can be optimally used. The microchannels with a large channel depth or cross-sectional area are arranged in the thicker region of the wedge-shaped plates while the microchannels with a smaller channel depth or cross-sectional area are disposed in the thinner region of the plates. In a complex design, this makes it possible to space the outlet openings of the microchannels of the last bifurcation stage close together. The mixing chamber can be rotationally symmetrical, preferably cylindrical, which enhances the mixing of the fluids introduced into the mixing chamber.

Such cylindrically shaped mixing chambers are superior to the mixing chambers described in the aforementioned prior art because the ratio of active to inactive surface is greater and the total throughput and mixing efficiency is better. The active surface is defined as the area from which the fluid streams exist, while the inactive surface is the area from which no fluid streams exit. In the rectangular mixing chambers of the prior art, one of six sides is used to supply fluids, whereas in the cylindrical mixing chamber, the entire lateral surface of the cylinder can be used.

The simultaneous use of bifurcation cascades as fluid guide structures and wedge-shaped plates as supply elements results in a micromixer that is suitable for reactions whose selectivity and reproducibility is sensitive to the mixing quality.

The pressure loss within the microchannels of stage i (i=1 to n, n≧2) can be further minimized by changing the geometric dimensions of the microchannels of different stages in relation to one another. The length of the microchannels can be shortened toward the mixing chamber (Lᵢ₊₁<L, where Lᵢ=the length of the microchannels of stage i). It was found to be advantageous to select the lengths in such a way that the ratio of the lengths of two successive stages is constant. Such bifurcation cascades are said to be self-similar.

Especially in cases where the number n of the stages is greater than or equal to 3, a preferred embodiment consists in reducing the dimensions of the microchannels from stage to stage only up to the penultimate stage. Thus, the bifurcation cascade can be self-similar up to the penultimate stage.

Preferably, at least one wedge-shaped plate is provided with grooves that form microchannels on at least one wedge surface. The micromixer can be assembled from a plurality of identical wedge-shaped plates to reduce production costs.

According to a further embodiment, the wedge-shaped plate is provided with a bifurcation cascade on both wedge surfaces. The microchannels of the last bifurcation stage opening onto the end face of the wedge-shaped plate are offset relative to one another, if possible in circumferential direction of the mixing chamber, so as to minimize the spacing.

In a further preferred embodiment, the wedge-shaped plate is provided with grooves that form a partial cross section of the microchannels on the two wedge surfaces. The grooves in the superimposed surfaces of two adjacent supply elements complement one another to form the full cross section of the microchannels. In this embodiment, the micromixer can again be assembled from a plurality of identical wedge-shaped plates to lower the production costs. This makes it possible to create flow-enhancing circular cross sections that would otherwise be difficult to produce.

In a further embodiment, the microchannels are configured in such a way that the width and/or depth as well as possible the length of the nth stage, i.e. the last stage prior to opening into the mixing chamber, is greater than in the previous stage (stage n−1), i.e. the penultimate stage. This makes it possible to achieve a higher ratio of active surface to inactive surface in relation to the lateral surface of the mixing chamber, which improves the mixing of the fluids. In principle, the grooves can be offset relative to one another in the individual supply elements such that, if two fluids A, B were alternately distributed over the individual supply elements, a partial stream of fluid B flowing into the mixing chamber would be surrounded by four partial streams of fluid A and vice versa. If the microchannel cross-section in the nth stage, particularly the microchannel width and/or depth, is enlarged compared to stage n−1, the outflow areas of the fluids can be made to overlap in axial or circumferential direction of the mixing chamber. If the distance between the exit areas is sufficiently small, the mixing contact area and thus the mixing efficiency is increased.

Preferably, the bifurcation cascades for each fluid are connected to a common supply channel. This helps ensure the similarity of the external conditions for the fluid streams and thus increases the reproducibility of the mixture.

To make the micromixer as compact as possible, a preferred embodiment provides that the common supply channels are integrated in the supply elements in the form of bores or are formed as grooves in the housing that surrounds the supply elements.

The embodiment of the supply elements as flat plates with an opening in their center into which the microchannels open, wherein the stacked plates together form the core piece of the micromixer and the stacked openings the mixing chamber, provides a particularly compact and stable micromixer that can be easily and cost-effectively produced. With respect to the advantages of the bifurcation of the microchannels, reference is made to the preceding description.

Particularly preferred are annular plates as the supply elements. With the use of annular plates, cylindrical mixing chambers are obtained, which have the advantage that the ratio of active to inactive surface is greater and, consequently, the total throughput and mixing efficiency is better.

The pressure loss within the microchannels of stage i (i=1 to n, n≧2) is minimized by shortening the length of the microchannels in the direction of the mixing chamber (Lᵢ₊₁<Lᵢ, where Lᵢ=the length of the microchannels of stage i). It was found to be advantageous to select the lengths in such a way that the ratio of the lengths of two consecutive stages is constant. Such bifurcation cascades are said to be self-similar.

As in the case of the wedge-shaped plates, the microchannels are preferably formed by grooves that are made in the plates. The micro channels of the one side are advantageously offset relative to those of the other. This reduces the spacing and thus increases the mixing efficiency.

In a further embodiment, the grooves of each supply element have a partial cross section of the microchannels, such that the grooves of the superimposed surfaces complement one another to form the full cross section of the microchannels. These and the aforementioned measures make it possible to reduce the production costs, since the micromixer can be assembled from a plurality of identical flat plates.

To make the micromixer even more compact, a preferred embodiment provides that the supply channels for the individual bifurcation cascades are integrated in the form of openings in the supply elements. It is important that each flat plate is also provided with openings for the supply channels to which no bifurcation cascade is connected in that particular plate. The micromixer can be constructed of identical supply elements, which are mutually rotated so as to form not only a continuous mixing chamber but also continuous supply channels for each fluid.

Exemplary embodiments of the invention will now be described in greater detail with reference to the drawings in which:

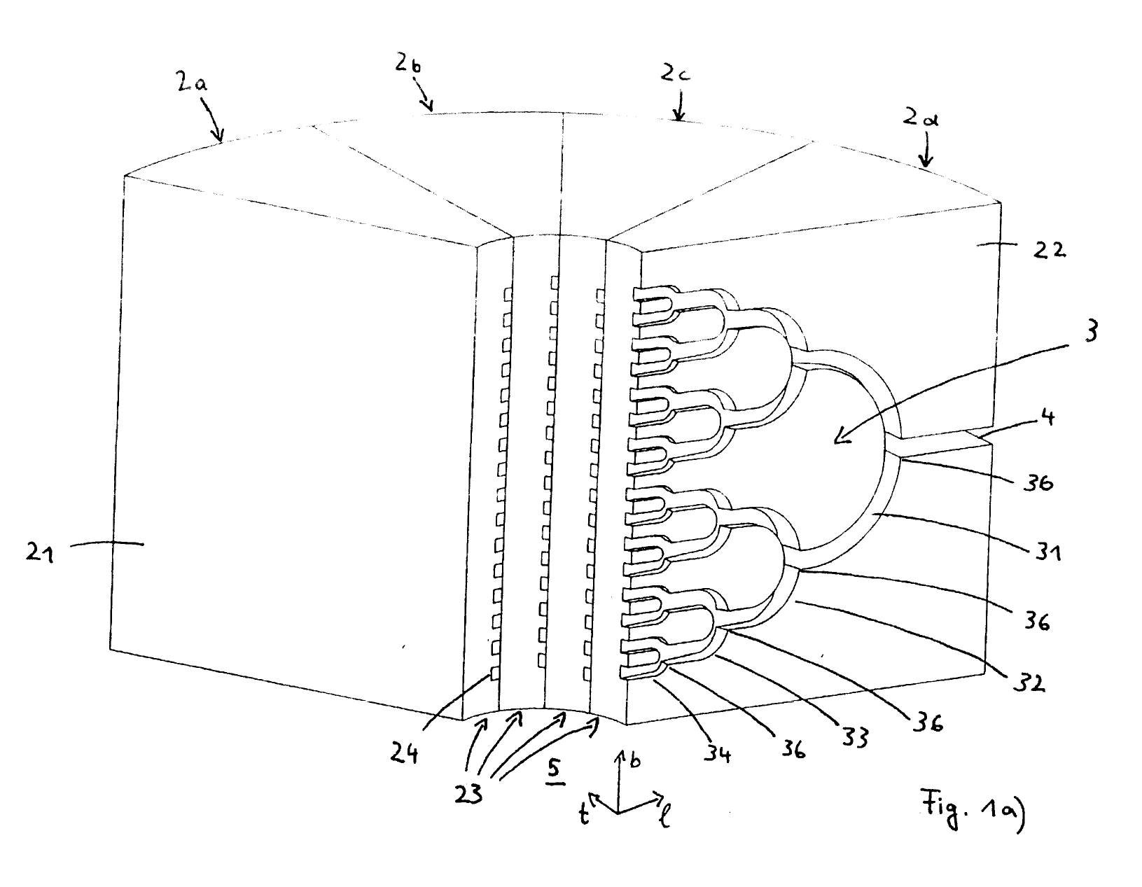

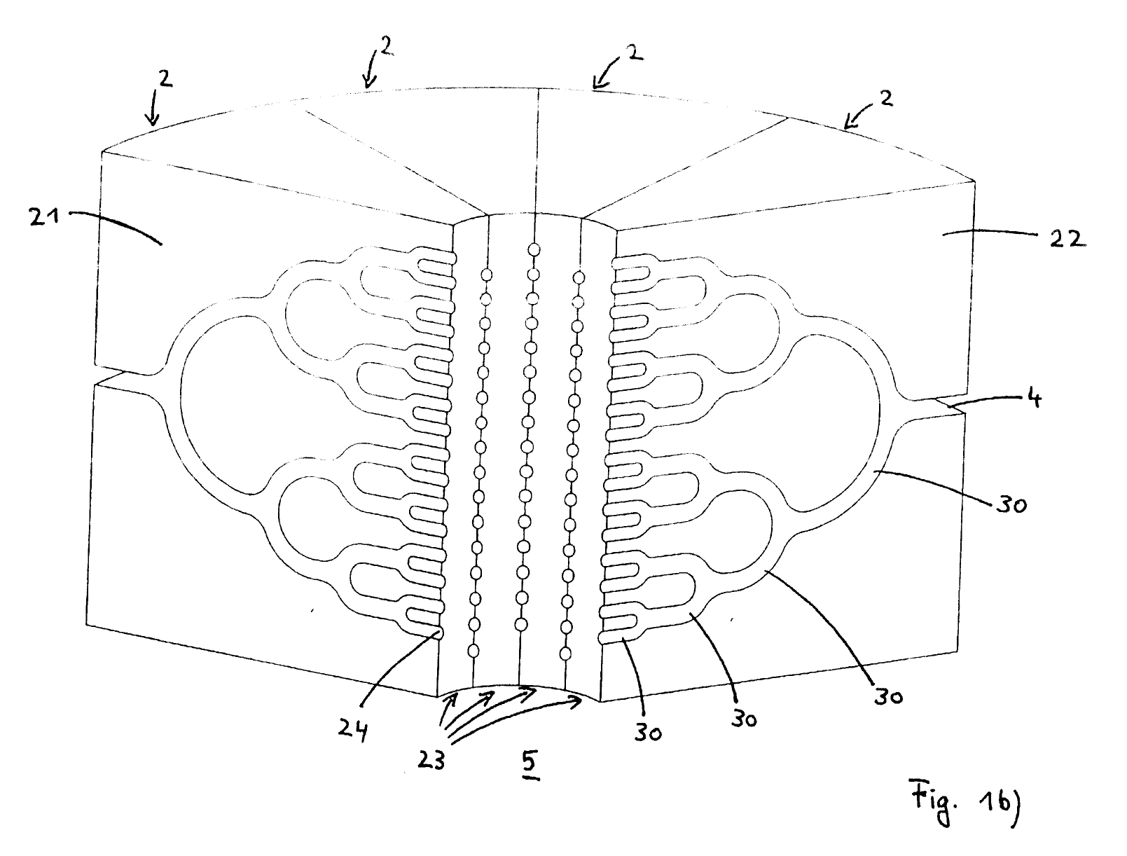

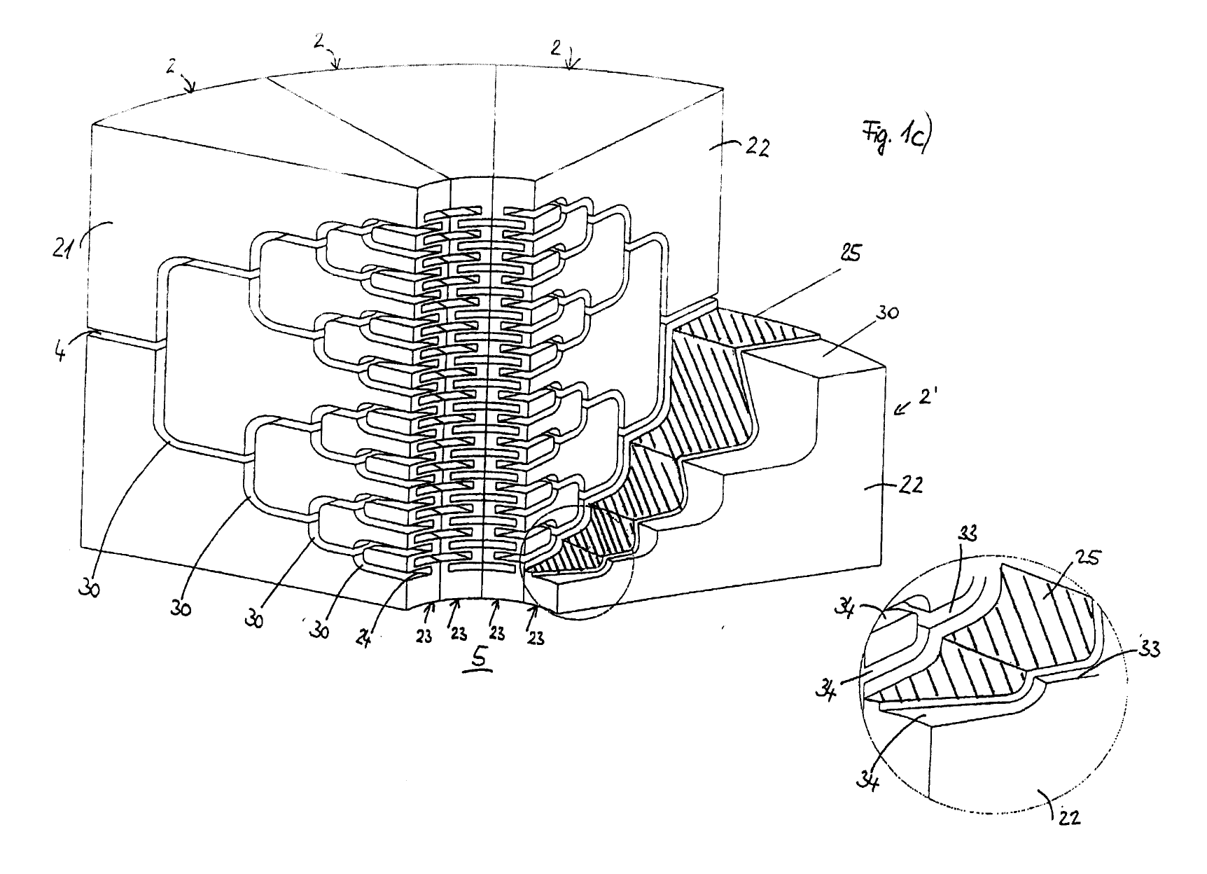

FIG. 1a is a perspective view of supply elements with grooves that form microchannels on one side,

FIG. 1b is a perspective view of supply elements with grooves that form microchannels on both sides,

FIG. 1c is another perspective view of supply elements with grooves that form microchannels on both sides,

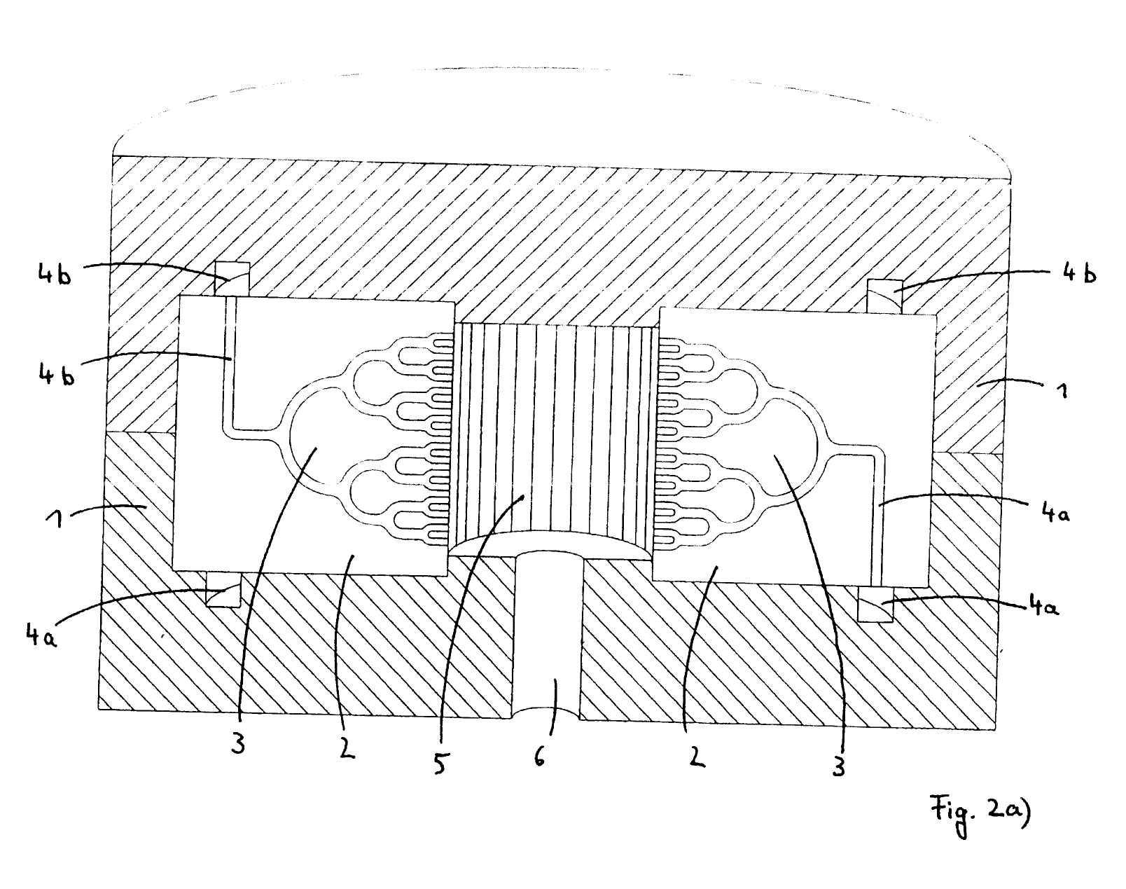

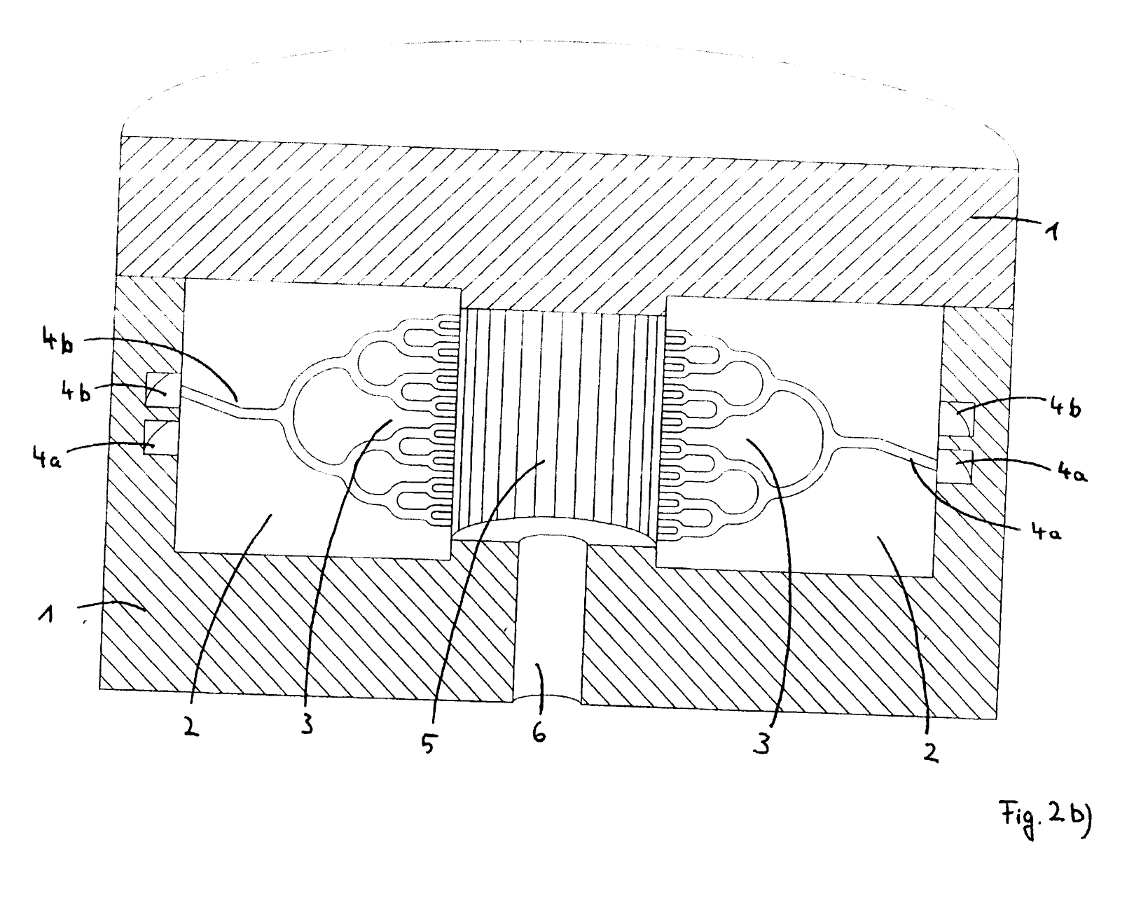

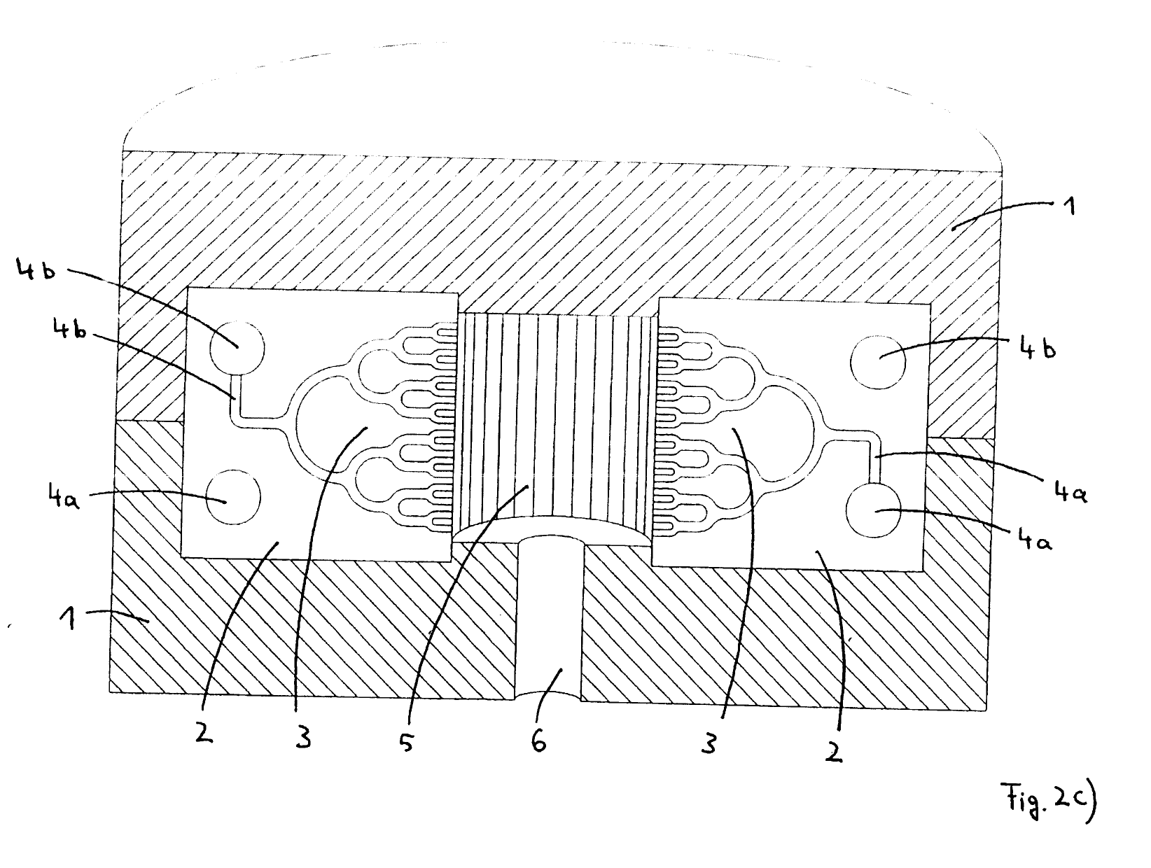

FIG. 2a is a perspective view of supply elements inserted into a housing with supply channels above and below the supply elements,

FIG. 2b is a perspective view of supply elements inserted into a housing with supply channels laterally of the supply elements,

FIG. 2c is a perspective view of supply elements inserted into a housing with supply channels that are integrated into the supply elements,

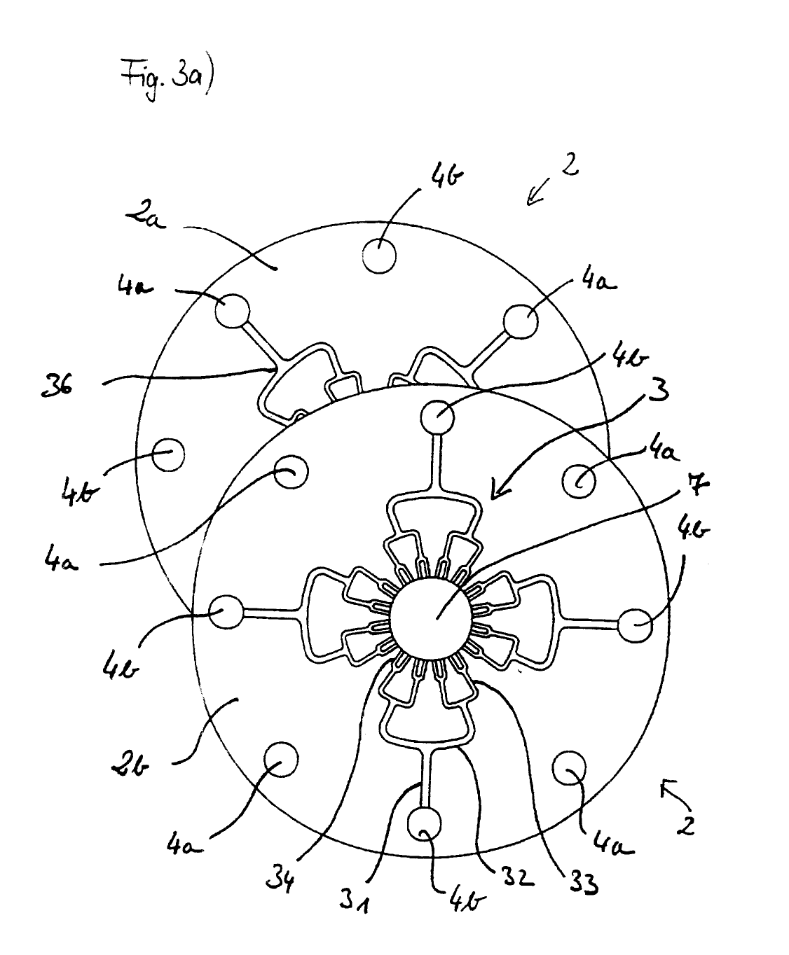

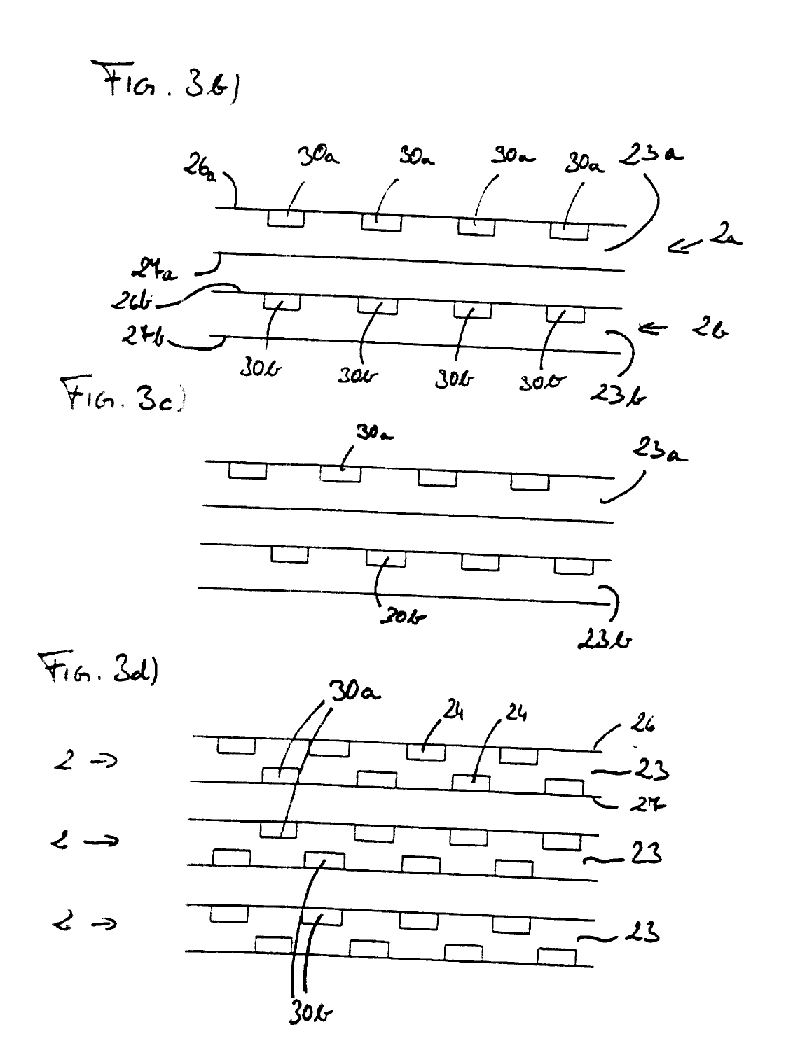

FIG. 3a is a top view of two supply elements, which are embodied as flat, annular plates,

FIGS. 3b-d illustrate different groove arrangements in supply elements that are embodied as flat annular plates.

FIG. 1a is a perspective view of a plurality of supply elements 2a-d that are assembled to form a ring sector. This creates a cylindrical mixing chamber 5, the lateral surface of which is formed by the end faces 23 of the supply elements 2a-d. Said supply elements 2a-d are wedge-shaped plates, in which one wedge surface 22, respectively, is provided with grooves 24 that serve as microchannels 31-34. A smooth wedge surface 21 covers the microchannels in the adjacent wedge surface 22. For the sake of clarity only one groove 24 and one microchannel 31-34 are identified by way of example.

For optimum use of the wedge shape of supply elements 2a-d, microchannels 31-34 and supply channel 4 are configured so as to have the same width but a different depth. The cross section in FIG. 1a is rectangular. After each bifurcation 36, the depth decreases from the exterior toward the interior in the direction of mixing chamber 5. The flow direction of the fluids is oriented radially from the exterior toward the interior. For wedge element 2d, a coordinate system is indicated with the directions l, b and t. The length of a microchannel is measured in direction l, the width in direction b, and the depth in direction t of a microchannel.

The fluid guide structure 3 in the example depicted in FIG. 1a is configured as a four-stage bifurcation cascade. From a reservoir located outside the device, the fluid stream flows into supply channel 4. Said supply channel bifurcates into two microchannels 31 of a first stage, such that the fluid stream is divided into two equal partial streams. The two microchannels 31 of the first stage each bifurcate into two microchannels 32 of the second stage so that in the second stage the original fluid stream is divided into four partial streams. In the example shown, this symmetrical bifurcation is continued up to the fourth stage and results in the division of the fluid stream into 2′ partial streams which flow from microchannels 34 of the fourth stage into mixing chamber 5, where they mix with the partial streams from the other supply elements.

In FIG. 1a, grooves 24 in supply elements 2a-d are offset such that—assuming that fluid A flows in supply elements 2a and c and fluid B in supply elements 2b and d—a partial stream of fluid B flowing into mixing chamber 5 is surrounded by four partial streams of fluid A and vice versa. This helps improve the mixing of the two fluids.

FIG. 1b depicts a further example of the configuration of supply elements 2. In this case both joint surfaces 21 and 22 are provided with grooves 24, which form a partial cross section of microchannels 30. When two wedge surfaces 21 and 22 are placed together, two opposite grooves 24 complement one another to form the full cross section of a microchannel 30. The cross section of microchannels 30 is rounded. Since in this case, too, the depth of microchannels 30 decreases toward the interior while the width remains constant, microchannels 30 have a round cross section directly at mixing chamber 5. For the sake of clarity, only one groove 24 and microchannels 30 of one partial stream are indicated in FIG. 1b.

FIG. 1c shows a further embodiment of supply elements 2. In this case, both the depth and the length of microchannels 30 decrease from stage i to stage i+1, but from stage n−1 to stage n, i.e. the last stage before opening out into mixing chamber 5, both dimensions increase again. This is also shown in the enlargement of the cut-way supply element 2′. Supply element 2′ is cut-away along section plane 25 such that a microchannel 30 is consistently cut along half of its width. The depth and length of the microchannel of the fourth stage 34 are clearly greater than the depth and length of the microchannel of the third stage 33. For the mixing chamber, this results in a higher ratio of fluid outflow surface to total lateral surface, which increases the mixing efficiency. Like in FIG. 1a, the individual grooves 24 are mutually arranged such that a partial stream of a fluid is surrounded by four partial streams of another fluid. Due to the large depth of the microchannels of the fourth stage 34, there is an overlap of the outflow surfaces in circumferential direction of the mixing chamber. This increases the mixing contact surface of the fluids flowing into the mixing chamber 5 and thus also the mixing efficiency.

In FIG. 2a, the supply elements 2 are inserted into housing 1. Housing 1 consists of two circular disks in which recesses are made to accommodate supply elements 2 and to form mixing chamber 5. Supply channels 4a and b are circumferentially arranged in housing 1 forming a ring above and below supply elements 2. In one of the two circular disks a fluid discharge channel 6 is arranged such that it opens centrally into the lower end face of mixing chamber 5.

FIG. 2b shows a different embodiment of housing 1 in which the two supply channels 4a and b are located in the same circular disk as fluid discharge channel 6 and laterally encircle the supply elements in housing 1.

FIG. 2c shows a further embodiment of both housing 1 and supply elements 2. In this case, the annular supply channels 4a and b are not located in the circular plates forming housing 1 but are through-bores integrated in supply elements 2 in the form of a ring extending along the circumference.

FIG. 3a shows two supply elements 2, each configured as a flat circular plate 2a, b. Plate 2b has a circular opening 7 in its center. Circular openings that form the supply channels 4a and 4b for fluids A and B are arranged along its circumference. Supply channels 4b of plate 2b are connected to bifurcation cascades 3. From each supply channel 4b issues one microchannel of the first stage 31, which after a bifurcation 36 divides into two microchannels of the second stage 32, which in turn each divide into 2+2 microchannels of the third stage 33, etc. The lengths of microchannels 31 to 34 decrease with each subsequent stage. Flat plate 2a is identical to flat plate 2b, but is rotated by 45° relative to plate 2b. As a result, the supply channels 4a of plates 2a and 2b and the supply channels 4b of plates 2a and 2b are superposed. From supply channels 4a in plate 2a issue bifurcation cascades 3 for fluid A. By stacking a plurality of plates 2a and 2b, a cylindrical micromixer is obtained.

FIGS. 3b to 3d illustrate possible arrangements of grooves 24 forming microchannels 30a, 30b in the upper side 26 and/or the lower side 27 of the supply element, which is configured as a flat plate 2 or 2a, b. For the sake of clarity, FIGS. 3b to 3d show plates 2, 2a, 2b spaced at a distance from one another. For reasons of stability it is also possible to introduce additional spacers between the supply elements, which would have openings for forming the mixing chamber and the supply channels but no bifurcation cascades.

In FIG. 3b the grooves in plate 2a and plate 2b are formed on the upper side 26a or 26b. The grooves in plate 2a form microchannels 30a for fluid A and the grooves in plate 2b form microchannels 30b for fluid B. The grooves in the two plates are arranged in such a way that the microchannels 30a and 30b are exactly superposed.

The groove arrangement in FIG. 3c is distinguished from the groove arrangement in FIG. 3b only in that the microchannels 30a and 30b are offset relative to one another. As a result the microchannel for one fluid is surrounded by four microchannels for the other fluid. This increases the mixing efficiency.

The supply elements 2 of FIG. 3d have grooves 24 on both their upper side 26 and their lower side 27. Grooves 24 each form a partial cross section of microchannels 30a and 30b and complement one another to form the full cross section of microchannels 30a, 30b in the superposed surfaces 26 and 27. This is why the grooves of the upper side 26 are offset relative to the grooves of the lower side 27. If the partial cross sections of the one side are used for the one fluid and the partial cross sections of the other side for the other fluid, one microchannel 30a or 30b for the one fluid is surrounded by four microchannels 30b or 30a.

### LIST OF REFERENCE NUMERALS

1 housing

2a, b, c, d, 2′ supply element

3 fluid guide structure

4a,b supply channel A, B

5 mixing chamber

6 fluid discharge channel

7 opening

21 wedge surface

22 wedge surface

23 end face

24 groove

25 cut plane

26 upper side

27 lower side

30a,b microchannel A, B

31 microchannel of the first stage

32 microchannel of the second stage

33 microchannel of the third stage

34 microchannel of the fourth stage

36 bifurcation

1. Static micromixer with supply chambers for at least two fluids to be mixed, from which microchannels lead to a mixing chamber, wherein said microchannels are arranged in at least two adjacent supply elements, characterized in that
the supply elements (2) are wedge-shaped plates, which can be assembled to form at least one ring sector that surrounds the mixing chamber (5) in a curve, and
the microchannels (30) provided for each fluid form a symmetrical bifurcation cascade comprising at least two stages i (i=1 to n, where n≧2).

2. Micromixer as claimed in claim 1, characterized in that the cross section of the microchannels (30) decreases from stage to stage.

3. Micromixer as claimed in claim 1 or 2, characterized in that the length of the microchannels (30) decreases from stage to stage.

4. Micromixer as claimed in any one of claims 1 to 3, characterized in that the bifurcation cascade is self-similar.

5. Micromixer as claimed in claim 1, characterized in that the cross section of the microchannels (30) decreases from stage to stage up to stage n−1.

6. Micromixer as claimed in claim 1 or 5, characterized in that the length of the microchannels (30) decreases from stage to stage up to stage n−1.

7. Micromixer as claimed in any one of claims 1 to 6, characterized in that the at least one wedge-shaped plate is provided with grooves (24) forming microchannels (30) on at least one wedge surface (21, 22).

8. Micromixer as claimed in claim 7, characterized in that the wedge-shaped plate has a bifurcation cascade on each of the two wedge surfaces (21, 22), wherein the microchannels (30) of the last bifurcation stage, which open out at the end face of the plate are offset relative to one another.

9. Micromixer as claimed in claims 7 or 8, characterized in that the grooves (24) of each supply element (2) form a partial cross section of the microchannels (30), and the grooves (24) located in the superposed surfaces complement one another to form the full cross section of the microchannels.

10. Micromixer as claimed in any one of claims 5 to 9, characterized in that the cross section and/or the length of the microchannels (30) increases from stage n−1 to stage n.

11. Micromixer as claimed in any one of claims 5 to 10, characterized in that the microchannels (3a) opening out into the mixing chamber (5) overlap in circumferential or axial direction of the mixing chamber (5).

12. Micromixer as claimed in any one of claims 1 to 11, characterized in that the bifurcation cascades for each fluid are connected to a common supply channel (4a, b).

13. Micromixer as claimed in claim 12, characterized in that the common supply channel (4a, b) is arranged in the supply elements (2).

14. Micromixer as claimed in claim 12, characterized in that the common supply channel (4a, b) is arranged in a housing (1) surrounding the supply elements (2).

15. Static micromixer with supply chambers for at least two fluids to be mixed, from which microchannels lead to a mixing chamber, wherein said microchannels are arranged in at least two supply elements, which are directly superposed or are spaced apart from one another by one or more spacer elements, characterized in that the supply elements (2) are flat plates which are provided with an opening (7) in their central region, such that the stacked plates form the mixing chamber (5), and the microchannels (30) provided for each fluid form one or more symmetrical bifurcation cascades comprising at least two stages i (i=1 to 1, where n≧2).

16. Micromixer as claimed in claim 15, characterized in that the flat plates are circular.

17. Micromixer as claimed in claim 15 or 16, characterized in that the length of the microchannels (30) decreases from stage i to stage i+1.

18. Micromixer as claimed in any one of claims 15 to 17, characterized in that the bifurcation cascade is self-similar.

19. Micromixer as claimed in any one of claims 15 to 18, characterized in that at least one flat plate (2) is provided with grooves (24) forming microchannels (30) on at least one of its two sides (26, 27).

20. Micromixer as claimed in claim 19, characterized in that the flat plate has at least one bifurcation cascade on each of its two sides (26, 27), wherein the microchannels (30) of the two sides (26, 27) that open out into the opening (7) of the plate are mutually offset.

21. Micromixer as claimed in either claim 19 or 20, characterized in that the grooves (24) of each supply element (2) form a partial cross section of the microchannels (30), and the grooves (24) located in the superposed surfaces (26, 27) complement one another to form the full cross section of the microchannels (30).

22. Micromixer as claimed in any one of claims 15 to 21, characterized in that the bifurcation cascades are each connected to one of the supply channels (4a, b) arranged in the supply elements (2).
